(19) United States
(12) Patent Application Publication
(10) Pub. No.: US 2006/0036201 A1
(43) Pub. Date: Feb. 16, 2006

(54) Sound and vibration transmission pad and system

(76) Inventor: Daniel E. Cohen, Eden Prairie, MN (US)

Correspondence Address: John F. Klos, Esq.;Fulbright & Jaworski L.L.P., 2100 IDS Center, 80 South Eighth Street, Minneapolis, MN, 55402, US

(21) Appl. No.: 11/222,608

(22) Filed: Sep. 9, 2005

(30) Foreign Application Priority Data
Mar. 10, 2004 (WO) PCT/US04/07354

(51) Int. Cl. A61H 1/00

(52) U.S. Cl. 601/47

(57) ABSTRACT

The present invention is directed to a pad and sound transmission system which is adapted to directly transmit audible sound waves into the body at high intensity levels. In one embodiment, the pad is comprised of a padding material and speakers disposed within the padding material. The sound transmission system includes an amplifier, an automatic volume control, and a plurality of input parts. The pad includes a padding material comprised of a layer of highly porous material, a layer made of more dense foam and a stiff foam core in which the speakers are connected. The padding material preferably includes a plurality of openings that form resonant chambers that direct sound-generated vibrations to the shoulder blades, the center of the spine, and the hips of the user.

### FIELD OF THE INVENTION

Generally, the invention relates to a pad or similar apparatus for sitting on or lying upon. More specifically, the invention relates to a pad or similar apparatus capable of transmitting vibrations generated by a sound source to a user's body.

### BACKGROUND OF THE INVENTION

Sound therapy is a procedure used to promote healing and relaxation. Just as high intensity inaudible sound waves can be used to disintegrate a kidney stone, many believe that audible sound transmitted into the body can break up emotional and/or mental blocks (interferences with the normal flow of a person's life energy), which could then result in healing. It is also believed that various organs each have their own specific frequencies at which they resonate when in a state of health, and exposing unhealthy organs to their “healthy” frequencies will assist them in returning to their normal state of resonance and health. It is even conceivable that music and sound transmitted into the body somehow delivers some unknown or undetermined energy, based upon the intent of the composer or performer, that is responsible for healing. Possibly, all of these mechanisms are at work to some degree in a synergistic fashion to promote healing.

A secondary benefit of sound therapy is in its ability to promote relaxation or meditation. The medical literature contains hundreds of articles describing the health benefits of relaxation and meditation. These meditation or relaxation states counter the pathologic effects of stress on the body and the mind. Relaxation techniques and meditation have become complementary treatment modalities used in the therapy of many illnesses.

Learning how to relax physically requires that a person become more aware of how their body feels. Most people are not well grounded in the physical (they do not derive their awareness from all aspects of themselves, including their bodies) and therefore, they do not feel their bodies very well. They generally become more aware of their physical bodies only when they experience discomfort or pain or when they have a physical illness. When they are not in distress their focus is generally external to themselves, perceiving the outer world almost exclusively with their physical senses, most notably with their eyes and ears. This is why people are generally not very body-centered and why more subtle bodily sensations tend to be ignored.

In a state of reduced bodily awareness, it is difficult to perceive the degree to which one is physically relaxed. Therefore, to become more physically relaxed, one must develop a greater appreciation of how their body feels. Greater intensity of stimulation causes greater neuronal recruitment along the neurologic pathways and at the neo-cortex of the brain, enabling greater perception. This is especially important for those areas of the body that have less dense neuronal supply, such as the back of the torso.

Just as music that is heard stimulates the auditory cortex directly, music that is felt directly by the person's body stimulates the much larger somatosensory cortex, thereby simultaneously impacting more of the brain's primary sensory cortex. Two mechanisms may be invoked as a result of this direct stimulation—entrainment and habituation—both of which are sensitive to changes in the intensity of the stimulus and both of which can lead to greater physiologic relaxation.

Entrainment is a vibrational phenomenon whereby an oscillatory stimulus from one source can influence another object or living system by changing its oscillatory rate. The most cited example is one of a roomful of grandfather clocks, which after having been started with their pendulums swinging differently then become entrained such that all their pendulums swing alike. Rhythmic music with a beat of 60 beats per minute has been shown to have an entrainment effect upon a person's breathing, heart rate and brain waves, causing them to slow down. Greater intensity allows the entrainment effect to penetrate to deeper levels of the physical body.

Habituation is a neurological phenomenon that causes a person to become less aware of repetitive stimuli. Experiments have shown that humans habituate quickly to repetitive auditory stimuli. This process can reduce the perceived volume of the sound through active inhibition of the neurons involved in the transmission of the signal. The addition of a tactile component with the use of this invention introduces the repetitive stimulus to another larger cortical area. Therefore, through habituation, an even greater amount of brain tissue can be inhibited. This process of habituation, in effect, desensitizes the brain to the outside world creating less outer distraction in the presence of a repetitive stimulus. Greater intensity allows for both more neurologically widespread and a greater level of habituation achieved more rapidly. This phenomenon is also responsible for other benefits such as relief of chronic pain states due to the neuronal inhibitory/blocking effect.

Practitioners of sound therapy play pre-recorded music, instruments and/or create music and sound vocally for patients, or have the patients participate directly by playing instruments, singing, humming, toning or chanting. When a patient sings, hums, tones or chants they expose their body more directly to the sound waves since the body itself is generating the various frequencies or sound waves internally. Many people, however, are unwilling or unable to create sounds for themselves and must rely on sound sources external to their bodies.

When a person listens to music external to their body, very little of it is transmitted into their body, and therefore the therapeutic impact is limited. This is because the intensity of audible sound is typically kept below 85 decibels to prevent damage to sensitive inner ear mechanisms (OSHA 3074). In a report published in the Journal of Sound and Vibration in 1978, it was reported that only up to 2% of the sound energy transmitted at 100 hertz is absorbed into the body. It is important to maximize the intensity of the sound stimulus, but yet avoid harmful exposure to the ear, in order to maximize the amount of sound energy or vibrations that can be absorbed into the body. Furthermore, recorded music or soundtracks typically have significant fluctuations in volume. Therefore, a single volume setting results in variable intensity of stimulus exposure when using pre-recorded music with the decibel level at times far exceeding the desired level, and at other times, being too low.

Consequently, there is a need for a device which will allow for greater transmission of audible sound into a person's body, while protecting a patient from possible hearing damage. There is also a further need for such a device to have the ability to automatically adjust its decibel output to compensate for fluctuations in volume inherent in the broadcasted sound.

### SUMMARY OF THE INVENTION

The present invention is directed to a pad and sound transmission system which is adapted to directly transmit audible sound waves into the body at high intensity levels. In one embodiment, the pad is comprised of a padding material and speakers disposed within the padding material. The sound transmission system includes an amplifier, an automatic volume control, and a plurality of input parts.

In one embodiment, the pad includes a padding material comprised of a layer of highly porous material, a layer made of more dense foam and a stiff foam core in which the speakers are embedded. The padding material preferably includes a plurality of openings that form resonant chambers that direct vibrations to the shoulder blades, the center of the spine, and the hips of the user.

In one embodiment, speakers are positioned to provide a greater distance between the speakers and the user's ears. This enables the user to increase the volume to increase the vibratory output without reaching audibly uncomfortable decibel levels. Generally, any commercially available speaker can be used in the present invention, and preferably speakers that can transmit a range of frequencies from about 20 hertz to 20,000 hertz are used. Alternatively, other sound/vibration-emitting devices can be used.

Using the present invention, there is typically a 20-decibel drop in the sound level when a person lies on the transmission pad. Considering a 20-decibel reduction, music could be played at 105 decibels, which is a 100-fold increase in intensity, and still not harm the user's inner ear mechanism. As such, the present invention is able to produce greater stimulation during sound therapy treatments.

### BRIEF DESCRIPTION OF THE DRAWINGS AND FIGURES

For purposes of facilitating and understanding the subject matter sought to be protected, there is illustrated in the accompanying drawings an embodiment thereof. From an inspection of the drawings, when considered in connection with the following description, the subject matter sought to be protected, its construction and operation, and many of its advantages should be readily understood and appreciated.

FIG. 1 is an exploded view of one embodiment of the structure of the padding material.

FIG. 2 is an overhead plan view of layer C from FIG. 1.

FIG. 3 is an overhead plan view of layer A from FIG. 1.

FIG. 4 is an overhead plan view of one embodiment of a lower portion of the present invention.

FIG. 5 is a block diagram of one embodiment of the sound transmission system of the present invention.

### DETAILED DESCRIPTION OF THE PREFERRED EMBODIMENTS

The present invention is directed to a pad and sound transmission system which is adapted to directly transmit audible sound waves into the body at high intensity levels. In one embodiment, the pad is comprised of a padding material, speakers disposed within the padding material, and a sound system in communication with the speakers.

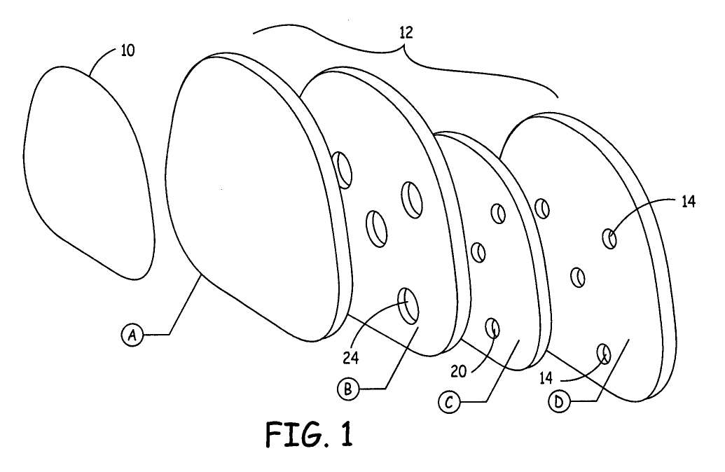

In the embodiment shown in FIG. 1, the pad includes padding material 12 comprised of 4 layers. Layer A is made of a highly porous material Layer B is made of more dense foam. Layer C is a stiff foam core and Layer D is made of a material of density similar to Layer B. Overlapping openings in layers B, C, and D define a resonant chamber within the padding material.

As shown in FIG. 1, the openings 20 in core Layer C determine the positions of the openings 24 in Layers B and openings 14 in Layer D. Preferably, the openings 24 in Layer B are somewhat larger than openings 20 in Layer C, and the openings 14 in Layer D are similar in size to the openings in Layer C. It will be understood by those skilled in the art that the size of the openings in the various layers will be dependent on many factors, such as the type of materials used and the shape of the speaker or other sound emitting device. The openings are preferably suitable sized to securely hold the speaker or other sound emitting device in the pad, particularly when the pad is in use. The chambers created by the juxtaposition of Layers B, C, and D and their corresponding openings create resonant chambers in which vibrations from the speakers can resonate and be transmitted through the porous top Layer A to the user.

The openings 14 in Layer D preferably go all the way through the thickness of Layer D. Alternative embodiments are possible in which some or all of the openings in Layer D are backed by an additional layer (Layer E, not shown) to form a sort of well or cavity instead. Preferably, the thickness of Layer D is approximately equal to the thickness of the magnet of the speaker to be positioned in the speaker chambers. The openings 14 in Layer D that are to receive the speakers preferably have a diameter somewhat less than the diameter of the speaker magnet to ensure a secure fit of the speaker magnet within opening 14.

In one embodiment, the openings 14 in Layer D corresponding to the resonant chambers wherein a speaker is received may be of a different diameter than those resonant chambers in which no speakers are positioned. For example, if a speaker magnet has a diameter of about 3 inches, the corresponding speaker-receiving opening in Layer D has a diameter of about 2.5 inches, while an opening without a speaker may have a diameter of about 4 inches. Other variations of the opening positions and diameters are contemplated by the present invention, and may be varied to achieve a desired result. Optionally, the pad of the present invention may include a pad cover 10, as shown in FIG. 1, preferably made of a flexible material such as fabric.

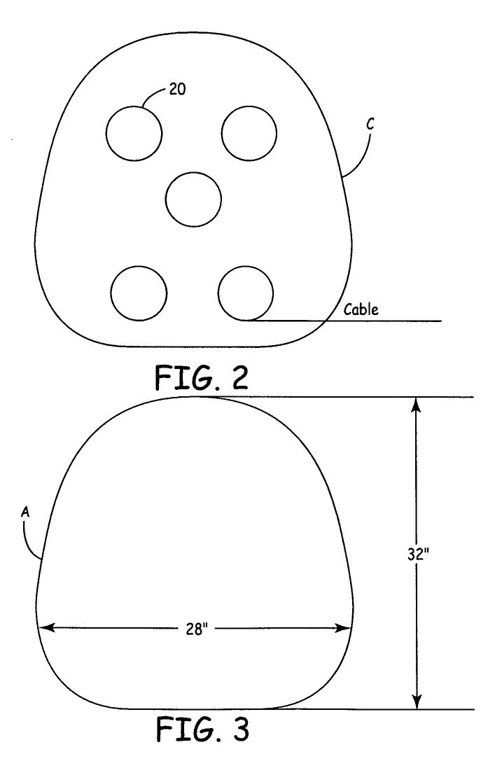

As shown in FIG. 2, layer C includes a plurality of openings 20 which are preferably spaced to generally correspond to the location of the shoulder blades, the center of the spine, and the hips of the user. Preferably, the lower portion of Layer C is wider than the upper portion to facilitate the user's arms and hands at the sides of the user's body during meditation. In one embodiment, speakers are positioned in the center opening and the two lower openings, but not in the upper openings, to provide a greater distance between the speakers and the user's ears. This enables the user to increase the volume to increase the vibratory output without reaching audibly uncomfortable decibel levels.

The openings 20 in Layer C can be of any dimension suitable for housing the speakers or other sound and vibration emitting device. Preferably, the openings are sized to comfortably and securely house the speaker, but with enough flexibility or space to enable removal of the speaker for repair or other adjustments. In one embodiment, the openings 20 in core layer C are between about 1 inches and about 5 inches in diameter, more preferably about 1.5 inches to 4 inches in diameter, and even more preferably about 2.5 inches in diameter.

The resonant chamber openings 24, 20, and 14 are preferably of a diameter sufficient to cause resonance within the chamber when the pad is in use. The openings in the core 20 at the site of these resonant chambers can be made to vibrate to a greater extent by placing outwardly radiating cuts in Layer C that intersect with the perimeter of the openings 20 to create segments. By creating these segments, the stiffer foam has greater freedom to vibrate at this site. The segments also allow for the transmission of vibrations with less energy, which will allow for the transmission of higher frequencies that are propagated with less energy. A similar effect can be gained by altering the shape of the opening 20 from a circle to a star shape, leaving a protuberances of material into the opening, which is surrounded by air. Placing a more fluidic material in the resonant chamber also will allow for greater transmission of the vibratory energy. Certain fluidic substances, when stimulated by the vibratory energy, can generate heat, providing an additional benefit. A stiffer material can also be placed at the rear of the resonant chamber to direct more vibration towards the user.

The layers of the pad of the present invention can be of any thickness suitable to support the user comfortably in relationship to the ground or other surface upon which the user plans to relax or meditate, and through which sound vibrations can be transmitted and experienced by the user. Although the layers can be of any thickness, it is preferably to minimize the separation between the speakers and the user's body to maximize the transmission of sound and vibration into the body. Layer A is preferably a very porous foam material through which sound waves are easily transmitted with little or no filtration or deflection, in unwanted directions, of the sound waves.

Generally, the thickness of the layers will vary from ¼ inch to 3 inches. Preferably, core Layer C is narrower than Layers A, B and D, and is made of firmer material to transmit vibrations through the pad more efficiently. In one embodiment, Layer A is about 1.25 inches thick, Layer B is about 2 inches thick, Layer C is ⅜ inch thick, and Layer D is 1 inch thick. Alternate embodiments are contemplated by the present invention, and those skilled in the art will appreciate that the various thickness of the layers and the number of layers used will depend on many factors, including the types of pad materials and types of sound emitting devices used to make the pad of the present invention. In some embodiments, for example, a very simple assembly of a speaker supporting layer and a user supporting layer can make up the pad of the present invention.

The materials used to make the pad of the present invention can be any types of materials which support the user's body comfortably, and through which sound vibrations can be transmitted by speakers and felt by the user. It is preferred that the materials used have little or no filtration, deflection in unwanted directions, or other effects on the sound waves (and corresponding vibrations) generated by the speakers. Preferably, a continuous material is used to make the layers of the pad. Particulate materials, such as buckwheat, shredded foam rubber, and the like, are believed to cause too much sound wave filtration of various frequencies and too much deflection of the sound waves away from the user's body to be efficacious in the pad of the present invention.

Another aspect of the present invention is to allow for maximum flexibility so that the pad can be used in many different locations and squeezed into tight places if necessary. The flexibility of the pad also increases its portability. Therefore, the support of the stiffer music/vibratory sources is preferably encased in a maximally flexible shell with a flexible cover, such as fabric. Unlike other devices for delivering music, the present invention does not require a resonant chamber having rigid members. This allows the pad of the present invention to be of sufficient flexibility for a variety of configurations without needing to re-orient the sound/vibration emitting devices. A handle can optionally be added to the cover or affixed to the underlying foam to facilitate transport.

In one embodiment, the top Layer A is preferably made of more porous foam, such as reticulated polyurethane filter foam. Layers B and D are made of a denser but still flexible polyurethane foam, or a visco-elastic polyurethane foam. Layer C is made of a more stiff or rigid core-type material, which can transmit vibrations emanating from the speakers or other sound or vibration source. One preferred material for Layer C is polyethylene foam.

The characteristics of visco-elastic polyurethane foam allow for greater conductance of sound and vibration in addition to greater comfort. Using a visco-elastic polyurethane foam or another conductive material creates a more uniform sensation of sound and vibration from the entire surface of the pad. In one embodiment, a visco-elastic polyurethane foam can be used in the pad in only selected areas to avoid sound transmission too close to the ears or too close to the periphery of the pad.

When using a visco-elastic polyurethane foam or another conductive material in Layer B, it is possible to extend the material of this layer laterally from the pad. This can be done to conduct sound and vibration into connections or appendages of the pad that can be configured as arm or leg sleeves or attachments that can be used to cover or wrap around portions of the front or sides of the body. Adding an adjustable heating element in proximity to this layer when using a visco-elastic polyurethane foam or another conducting material also serves to warm the user and distribute the warmth to the extensions of this layer. This is particularly useful for users that have reduced circulation to their extremities. The heating element can be attached to this layer more centrally within the pad or outside the pad towards the periphery of the appendage.

Preferably, the visco-elastic polyurethane foam used in one embodiment of the present invention has a density of between about 3.5 to 4.5 lbs/ft³, an indent force deflection at 25% of about 8 to about 12, a tensile strength of about 10 psi, a tear strength of about 1.0 lbs/linear inch, and demonstrates 100% elongation, all properties measured using the ASTM D-3574-86 testing methods. An example of a suitable visco-elastic polyurethane foam for use in the present invention is “SR38” Foam available from Amcon/VAS, Minneapolis, Minn., although other materials meeting these characteristics are also suitable for use in the present invention.

In one embodiment, Layer C is made of a more stiff or rigid core-type material, which can transmit vibrations emanating from the speakers or other sound or vibration source. One material for Layer C is polyethylene foam. To provide greater structural support for the pad and protection of the speaker cones, Layer B can be comprised of two layers, having a first layer of stiffer material similar to Layer C, on top of which a second layer of the visco-elastic material is positioned.

For example, Layer C may be made of a polyethylene foam core material having a density of about 1.9 lbs/ft³, a compressive strength at 25% of about 11, a vertical direction at 50% of about 21 psi, a compression set of about 15.5%, a tensile strength of about 40 psi, a tear resistance of about 17 lbs/in, a cell size of about 0.4 microns, and a buoyancy of about 60 lbs/ft³, all properties measured using the ASTM D-3575 testing methods. An example of a suitable polyethylene foam for use in the present invention is “Polyflex 19” Foam available from Amcon/VAS, Minneapolis, Minn., although other materials meeting these characteristics are also suitable for use in the present invention.

The speakers can be any type of conventional stereo speaker. The speaker is typically comprised of a speaker cone, a speaker magnet and a speaker frame which supports the cone and magnet. In one embodiment, a commercially available stereo speaker having an outermost diameter of 5¼ inches was used. Generally, any commercially available speaker can be used in the present invention, and preferably speakers that can transmit a range of frequencies front about 20 hertz to 20,000 hertz are used. The speakers are wired through a connecting cable, and are wired either in series or in parallel to maintain stereo quality of the sound being emitted. Preferably, a single connection to the sound system is utilized. It is also contemplated that wireless communication or multiple connections to the sound system may be utilized. Alternatively, other sound/vibration-emitting devices can be used.

The speakers are preferably attached to Layer C by the speaker frame. Layer C carries the musically generated vibratory waves to resonant chambers having no speakers therein. Laminating portions of Layer C with an aluminum film, or similar material, for instance, can be accomplished to conduct more vibratory energy from the speaker frames to the resonant chambers or elsewhere on the pad without significantly reducing the flexibility of the device.

Since the user will be applying pressure to the upper surface of the pad, and the speaker cone faces the upper surface of the pad, preferably a protective member is used to avoid damage to the speaker cone. To protect the speaker cone, for example, a circle of more rigid material is adhered to the speaker frame between the rubber material that suspends the cone and the outer front edge of the speaker frame (about 5/16″ thickness—between inner and outer diameter, in one embodiment). The height of the more rigid material can vary depending on the thickness of the pad and the strength of the material used, and preferably can range from about ¼ inch to about ½ inch. The outer diameter of the foam circle slightly exceeds the diameter of the speaker frame at this site to create an outward bending from the attachment site (circle of foam to speaker frame) to the free end of the circular foam material. In this manner, the circular foam more directly opposes the softer collapsing foam which surrounds the circle of more rigid foam, as it collapses in from the side. To further protect the speaker cone, an inner and outer cover can be placed around the foam construction to laterally spread any force, which is applied directly over the speaker well.

The pad may be assembled by positioning the speakers in Layer C, then attaching Layer D to the back of Layer C. The speaker cables are attached to the front side of Layer C and are preferably wrapped together to form a single robust cable. Layer B is then positioned on top of Layer C, and Layer A on top of Layer B. The layers may be attached to each other by an adhesive, and the entire assembly is preferably housed in a removable outer cover. The outer cover is preferably washable or cleanable, and as described above, is made of fabric or a similar flexible material that does not cause substantially any or much interference in the transmission of the sound waves from the speakers to the user's body.

The pad of the present invention can be of any size, but preferably has dimensions that enable it to be comfortably used for relaxation or meditation and that enable its user to store it and move it as convenient. Top Layer A is shown in FIG. 3. As described for Layer C, the lower portion of Layer A is preferably wider than the upper portion of Layer A to accommodate the user's arms and hands during meditation. In one embodiment, the pad of the present invention has a maximum width of between about 18 and about 30 inches, and a length of about 16 to about 35 inches. In another embodiment, the pad of the present invention has a maximum width of about 28 inches and a length of about 32 inches.

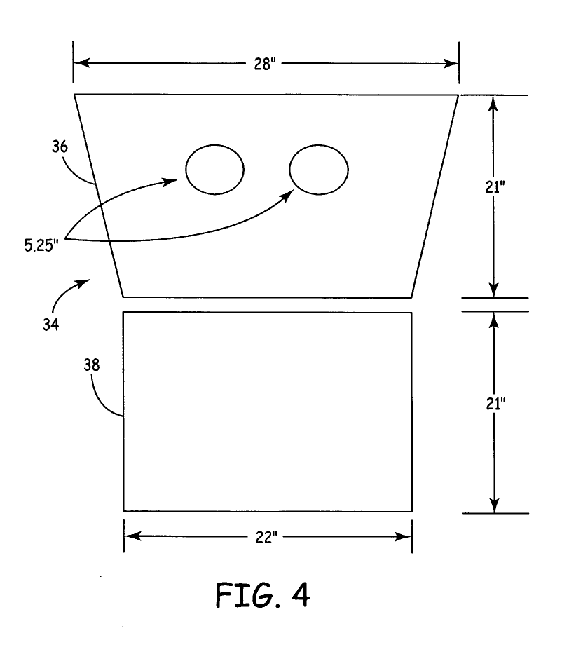

In the embodiment shown in FIG. 4, the present invention includes an additional lower pad 34 shaped to support the body from the waist to the feet. The shape of lower pad is preferably somewhat more rectangular. It is formed in two sections, although the lower section may be omitted, with the upper section 36, in one embodiment, being about 28 inches at the top, narrowing to about 21 inches at the bottom, and being about 21 inches long from top to bottom. The lower section 38 in this embodiment is about 21 inches wide at the top and bottom and about 21 inches long. Preferably, there is fabric material or other connective element that connects the upper and lower sections. The construction of the upper section is identical to the construction of the top pad and it houses two speakers 40 that are spaced apart identically to the lower two speakers in the top pad.

The lower pad 34 is composed of a lower layer of support foam and a softer foam layer on top of the support foam to better cushion the user's heels and feet. This provides pressure relief and reduces pain in the heels. This segment of the pad can also be designed to allow the user's feet to sink into the foam such that the user's knees can have a slight bend so that the user can be more comfortable. This can be accomplished by selecting softer foam in the lower section and/or by using foam construction of less depth than the top section of the lower pad.

By having the lower pad 34 constructed as two segments, it can easily be folded upon itself for easy storage and greater portability. It also allows for easier usability in the event that the user wishes to use the entire pad system in the sitting position—top pad positioned behind the torso, top segment of the lower pad under the seat and the lower segment of the lower pad behind the lower legs or folded beneath the top section of the lower pad.

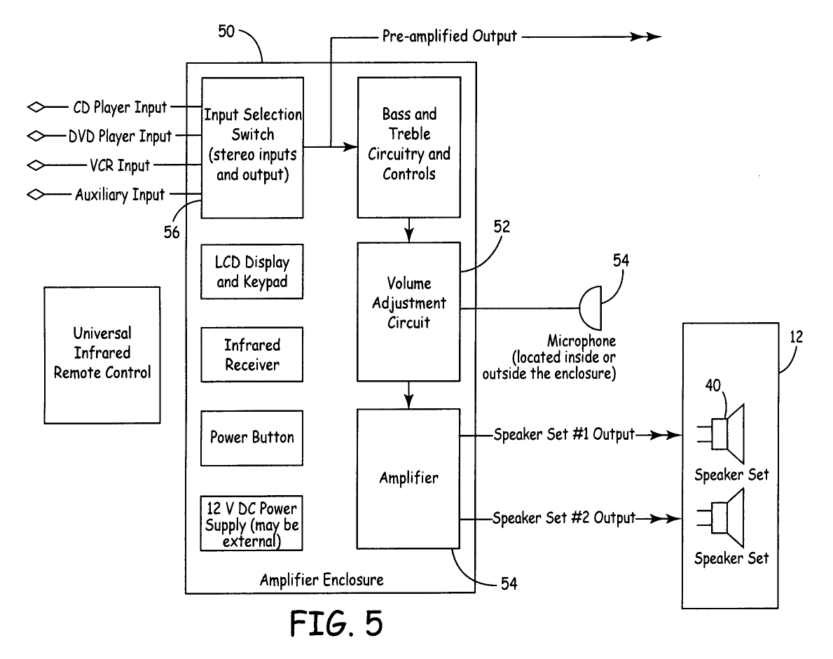

As shown in FIG. 5, the speakers 40 disposed in the resonant chambers communicate with a sound system. Typical attachments are in the rear of the amplifier often necessitating awkward installation. To increase ease of use and increase the likelihood of use, the cable from the pad to amplifier is created in two segments with a simple connector between the two segments. In this way, a segment of cable can remain connected to the amplifier, while the pad with the segment of cable attached to the speakers within the pad can be put away when not in use. Therefore, the user only need make the connection to the amplifier once and use the simple, time-efficient connection means just prior to use.

It is important to maximize the intensity of the sound stimulus, but yet avoid harmful exposure to the ears. Recorded music or soundtracks typically have significant fluctuations in volume. Therefore, a single volume setting results in variable intensity of stimulus exposure when using pre-recorded music with the decibel level at times far exceeding the desired level and at times being too low. Therefore, it is preferable to provide a system in which the user sets a volume level, and the sound system 50 adjusts the output of an amplifier 54 based upon the reading of a decibel meter or sensor 54.

In one embodiment, a sound intensity sensor is placed proximal to the user. This sound intensity sensor transmits a signal corresponding to the decibel level to a microprocessor in the automated volume control 52, which executes an algorithm designed to maximize intensity of stimulus exposure, but to not exceed the user defined volume level. Therefore, hearing loss/ear damage can be avoided, while providing a maximum user-defined intensity.

A minimum level can also be specified so that harder to hear segments can be further amplified if desired. The output of the microprocessor is transmitted to a controller, which automatically adjusts the speaker volume. The user has the ability to disengage the system manually or remotely. This system is particularly useful when the user engages (lies on or leans against) the pad and the volume drops or when the user gets off the pad and the volume abruptly increases. The amplifier and/or remote unit can also be supplied with a digital readout of the decibel level in the event that the user disengages the automatic adjustment means in favor of manual volume level setting.

Another method of automatically adjusting the output volume of the pad is to utilize pressure, light or heat sensitive switches placed on or in the pad or on or in the structure supporting the pad, such as a chair, a floor, or other surface. The switch or switches can be positioned anywhere in communication with the pad and the sound system, depending on such factors as ease of use and ease of manufacture. In an embodiment utilizing a pressure sensitive switch, for example, the switch is open (sound sources will then not transmit sound) until pressure is placed against the pad thereby closing the circuit. This can serve as an on/off mechanism for the entire pad. Switches can also be inserted in the circuitry for each or a subset of the sound sources within the pad such that only the sound sources receiving the relevant signal will emanate sound. This method of use is particularly helpful when multiple transmitting pads are all simultaneously connected to a sound or music source, but only some of the pads are in use or in partial use. Such situations include, but are not limited to, movie theaters, automobiles, or office spaces. Manual switches can also be used in the place of automatic switches on or in the pad, or on or in the cable between the amplifier and the pad, for this function.

The present invention may also include a plurality of input ports which allow the sound system to be connected directly to the audio output jacks of a television or a VCR or other digital equipment. The sound system 50 also includes an input selection switch 56 which enables the user to select which device to use as a sound source.

The sound system 50 of the present invention can accept audio output from a VCR, DVD, CD or MP3 player, or other electronic devices that have audio output capabilities. The audio output of the amplifier can be sent to other external speakers in addition to the pad. Using the automatic volume adjustment capabilities of the present invention therefore allows for automatic volume adjustment of all of the sound sources to be transmitted through the pad or other external speakers.

Splitter cables may be used to simultaneously connect the VCR to the system's amplifier and the VCR to the television so that both sound sources can be volume controlled independently. In this manner, one can have all or most of the volume felt and heard from the pad or, alternatively, when the pad is not in use, all of the volume can be heard from the television. The automatic volume adjustment capability of the amplifier is also useful in this application as television broadcasters often increase the volume during airing of commercial advertisements, which can automatically be reduced through customization of the amplifier's user defined volume parameters.

One of the major issues related to the construction and use of this type of device concerns the need for musically created vibration (exposing the person to many frequencies delivered in a format that is pleasing to listen to) at a sufficient level to be felt throughout the body, while maintaining a volume level that does not substantially damage the ears (<85 decibels) or is uncomfortable to listen to. Speakers must be positioned far enough away from the ears to avoid high intensity sound delivered to the ear. It is also helpful if the speakers are positioned under or adjacent to significant skeletal structures (spine, pelvis, femur, etc.) that can facilitate transmission of resonant frequencies throughout the body.

Preferably, the sound and vibration transmitting pad has sound/vibration-emitting devices located distally from the user's ears to permit generating sound at substantially higher decibel levels than would be tolerated by the user's hearing mechanisms. Preferably, the sound-emitting devices are positioned under more dense body regions of the user. Placing the speakers away from the ears reduces the decibel level that the ears are exposed to. Additionally, placing the speakers under denser body regions allows for absorption and transmission within the body of a significant amount of the sound energy, thereby reducing the sound waves (volume/loudness) in the air around the user, further reducing the loudness. Both techniques provide users with a wider range of available amplification of the music (so that they can create the desired level of vibration), when they are lying or leaning on the pad, without experiencing too much loudness in their ears.

In one embodiment, three speakers or vibratory sources are strategically placed on the back of the hips and the spine (at the level of the heart) to accomplish the objective of generating higher decibel levels without causing aural discomfort. Additional speakers may optionally be used. The hip speakers provide stimulus to the lower body including the lower abdomen, low back, pelvis and legs. The spine speaker stimulates the spine, skull, chest and upper abdomen. Resonant spaces are located at the approximate level of the shoulder blades to provide a vibratory stimulus to the upper chest and back, which radiates down the arms. The pad is constructed with a wider lower portion so the user can rest his or her lower arms, wrists or hands on the pad adjacent to the hip speakers, providing additional stimulation.

In addition, the user may optionally use supplemental ear protection devices to reduce, but preferably not eliminate, the volume level of the emitted sound that is audible when the user is on the transmission pad. Such supplemental ear protection devices may include ear plugs, headphones, and the like. The use of these supplemental devices may permit raising the decibel level of the speakers even higher than 105 decibels without damaging the user's inner ear mechanisms.

Using the present invention, there is typically a 20-decibel drop in the sound level when a person lies on the transmission pad. Due to the logarithmic nature of the decibel scale, therefore, 99% of the sound signal is being transmitted directly into the body versus a much smaller amount, reportedly around 2%, when just listening to speakers placed away from the body. Therefore, music can be played above 100 decibels for bodily absorption of the sound waves while avoiding 85-decibel exposure at the ears. Considering a 20-decibel reduction, music could be played at 105 decibels, which is a 100-fold increase in intensity, and still not harm the user's inner ear mechanism.

Preferably, the sound transmitted through the pad into the user's body is provided at a decibel level greater than the level recommended for listening without causing inner ear damage, or about 85 decibels. More preferably, the decibel level used in the method and with the pad of the present invention is between about 90 decibels to about 115 decibels depending upon the mass of the subject's body. Even greater sound levels can be provided directly to the body with the use of protective means in or around the ears to block sound wave transmission. As described above, two mechanisms may be invoked as a result of this direct stimulation—entrainment and habituation—both of which are sensitive to changes in the intensity of the stimulus and both of which can lead to greater physiologic relaxation.

The present invention is, therefore, also directed to a method of inducing relaxation while maintaining mental wakefulness. Music and vibration stimulate emotional feelings. In a state of physical relaxation, in a comfortable and safe environment, one has the ability to experience one's emotional feelings much more completely. Most people suppress their feelings to a considerable degree. The ability to relax more completely depends upon the willingness to allow emotional feelings to flow and emerge. Blocked feelings or stuffed feelings create bottlenecks to that flow and impair emotional well being, which has a direct impact on the level of relaxation that can be attained. Suppression of emotional feelings reduces the ability to further relax because it requires a higher degree of watchfulness in order to keep these feelings suppressed.

The present invention, coupled with music, which evokes emotional feelings, brings blocked emotional feelings into awareness as a result of maintaining wakefulness, as discussed herein. Allowing these feelings to be experienced more completely, to be understood and expressed is part of the process that will enable greater relaxation and healing.

The present invention was also designed to assist a person in better perceiving their finer vibratory nature. The human nervous system is able to perceive a number of sensations. These include touch, taste, smell, sound and light. In regards to the sense of touch, humans can perceive light touch and hot and cold at the level of the skin and vibration and pressure more deeply. All of these aforementioned sensations are easy to perceive.

In a more relaxed state humans can perceive a finer vibration at the level of the skin first and with practice this can be felt deeper, throughout the body. In this feeling state, one is better able to perceive one's own energy system—that part of one that permeates and surrounds one's physical body. Developing and deepening this finer perception is an important process, as it can be used as a form of feedback informing a person of their level of relaxation. The more relaxed a person is, the better one can perceive this energetic aspect of oneself and the more one can allow it to develop.

The physical body is most relaxed during sleep. In that state, there is a lowered heart rate and blood pressure, greater muscle relaxation and a decrease in the rate of respiration (breathing). The depth of physical relaxation parallels the depth of sleep. Sleep is divided into two broad categories, REM (rapid eye movement or dream sleep) and Non-REM. Non-REM sleep is divided into four stages (1-4). Stages 1 and 2 are considered light sleep and stages 3 and 4 are deep sleep. The deepest level of physiologic relaxation occurs in stage 4, however the level of relaxation that is obtained even in light sleep often far exceeds the degree of physiologic relaxation that occurs during waking in a given individual.

Generally, people are unaware of what it feels like when they are profoundly relaxed during sleep. As such, it is difficult to replicate that feeling and that level of relaxation. The present invention was designed to help people become more aware of this relaxed state. Lying down on the pad in a darkened, comfortable room has a tendency to promote sleep. However, the two most impactful sensory modalities for maintaining wakefulness are touch and sound. Therefore, the use of this invention employs two competing influences—the tendency to fall asleep in a comfortable situation and sensory stimuli that promote mental wakefulness. Again, stimulus intensity plays a significant role by assisting a person in maintaining wakefulness when they have an even greater tendency to fall asleep. This increases the likelihood that wakefulness will be maintained allowing the person to be observant of greater physical relaxation as their body drifts towards a state of sleep. By retaining greater conscious awareness during this state one can better appreciate how their body feels when they are completely relaxed and therefore they can be more successful at replicating this feeling and relaxed state when they are awake.

Relaxation is a prerequisite for learning meditation. Meditation is best thought of as a state of being that transcends the rational and emotional processes that accompany the normal waking state and allows for an expansion of one's conscious awareness. Meditation is an excellent time to practice perceiving the finer vibratory nature of a person's energetic self, as one is learning to transcend the physical and the accompaniments of the personality. This finer vibratory sense is generally easiest to first perceive in one's hands. It feels somewhat like static electricity. It may be associated with the sensation that one's hands are swollen or puffy. Feeling this vibratory sense in one's hands can be facilitated by keeping them on the lower part of the upper pad or the top of the lower pad while meditating. Feeling the music and vibration will stimulate this finer vibratory sense and one's feeling nature. In time one can appreciate this vibration throughout one's entire body. Greater intensity of stimulation can facilitate this appreciation at deeper aspects of the physical body.

Many people, early in the process of learning meditation, become frustrated regarding their inability to block their thoughts and actively attempt to not think. That act alone is usually self defeating as they are using thought in an attempt to block thought. Alternatively, some use a mantra—a word or phrase repeated throughout the meditation—in an attempt to selectively focus on a particular thought. The mantra may be repeated typically silently, when focus has been lost, including the intrusion of unwanted thoughts. Ruminating, processing, analyzing or thinking will delay the development of a meditative state. Again, it is helpful to return one's focus to the feeling state, which will break the cycle of thinking and analyzing, thus allowing one to transcend thought. Providing a higher intensity sound stimulus directly into the person's body increases one's ability to experience this feeling state more completely.

The pad of the present invention enables the user to more quickly learn how to meditate and to simulate the physical feeling that the user can experience when their soul is better grounded in the physical body, which also deepens the meditative state. The feeling that the user has when the soul is more engaged in the physical body is a subtle vibratory sensation that can be felt throughout the body, but oftentimes it is best appreciated initially in the hands. By using the pad with music, the user can appreciate this feeling more easily and begin to develop the ability to appreciate the feeling independently of the pad, thereby deepening the meditative state more readily.

Use of the pad of the present invention facilitates a deeper meditative state. The vibratory (tactile sensation) and audio stimuli work to keep the person's mind awake, while the body can become more relaxed, since those learning meditation have a tendency to fall asleep or become sleepy and inattentive. Normally, as the user becomes drowsy, they become much more relaxed. By maintaining a higher level of conscious awareness of this deepening state of physical, emotional and mental relaxation, the person can more quickly learn to simulate this state, thereby deepening their meditative state. Learning to feel the engagement of the soul in the physical body simultaneously also aids in developing a deeper meditative state and is in its own right a significant goal of meditation.

Delivering music during meditation also aids in developing a deeper meditative state by making it easier for the subject to not think. Meditation is a state of being, not analyzing or processing mentally. The presence of music and vibration reduces the likelihood of thinking and more easily allows the user to attend to their feeling nature so that they can experience the fine vibratory sensation as opposed to thinking.

Meditation is best learned with regular (daily) practice at the same time of the day so that it becomes a habit and the user's body becomes acclimated to meditation at that time of day. Therefore, having a portable, inexpensive home unit is preferable for the sake of convenience and affordability.

In addition to facilitating relaxation and improving or enhancing a user's meditative state, the present invention is also useful as a method for maintaining mental wakefulness independent of a relaxed state. This can be most helpful during repetitive activities such as driving an automobile, operating equipment or any task that has a tendency to induce drowsiness or sleep. By selecting music or sound that is more stimulating, the user can maintain greater levels of wakefulness or be more likely to prevent drowsiness or sleep.

The present invention can also be used for entertainment during normal television viewing or while watching movies playing on a videocassette recorder (VCR) or digital video device. On average, people watch several hours of television or movies per day. Most households do not have expensive entertainment centers with surround sound speakers, although more than 95% of households have a VCR and television. In many households, the broadcast signal received by antenna or cable service provider or movies or games played from VCRs or other digital equipment is routed through the television thereby producing video and sound. The sound reproduced through the television set is of low quality and typically the low frequency content is reduced due to the low quality of the speakers. As a result those frequencies that can be best felt are reproduced in a reduced manner.

The present invention allows for the reproduction of a wider range of sound frequencies by routing the audio signal through the speakers in the pad. Watching television, while using the present invention, therefore can allow more practice time for developing one's sense of feeling and greater appreciation of the fullness of the audio signal.

The size, flexibility, portability and component nature of the pad facilitates its placement in a chair to optimize television viewing. Either the upper pad can be used alone or the upper and lower pads can be used together when in a more reclined position. A chair or other support structures constructed to house the top and bottom pads allows for optimal positioning of the user for all applications (relaxation, meditation, healing and entertainment).

The matter set forth in the foregoing description and accompanying drawings is offered by way of illustration only and not as a limitation. While a particular embodiment has been shown and described, it will be apparent to those skilled in the art that changes and modifications may be made without departing from the broader aspects of applicant's contribution. The actual scope of the protection sought is intended to be defined in the following claims when viewed in their proper perspective based on the prior art.

I claim:

1. An apparatus comprising:
a padding material; and
a sound emitting device at least partially disposed within the padding material, the sound emitting device adapted to receive audio signals from a sound source located external to the padding material.

2. The apparatus of claim 1, and further comprising a sound system in communication with the sound emitting device.

3. The apparatus of claim 2, and further comprising a noise level sensor in communication with the sound system.

4. The apparatus of claim 3, and further comprising an automated volume control.

5. The apparatus of claim 1, wherein the padding material has a resonant chamber therein.

6. The apparatus of claim 1, wherein the padding material includes a layer of polyethylene foam disposed adjacent to a layer of polyurethane foam.

7. The apparatus of claim 6, wherein the padding material includes a reticulated polyurethane filter foam.

8. The apparatus of claim 1 and further comprising a pressure sensitive switch coupled to the apparatus.

9. An apparatus comprising:
a padding material, the padding material having a resonant chamber therein;
a vibratory source disposed within the padding material; and
a sound source in communication with the vibratory source.

10. The apparatus of claim 9, wherein the vibratory source is a speaker.

11. The apparatus of claim 9, wherein the apparatus includes an upper portion configured to accommodate a person's upper body and a lower portion configured to accommodate a person's lower body.

12. The apparatus of claim 9, wherein the resonant chamber is positioned to direct a auditory signal to a person's shoulder blade.

13. The apparatus of claim 9, wherein the resonant chamber is positioned to direct an auditory signal to a person's spine.

14. The apparatus of claim 9, wherein the resonant chamber is positioned to direct an auditory signal to a person's hips.

15. The apparatus of claim 9, wherein the resonant chamber is filled with a fluid.

16. The apparatus of claim 9, and further comprising a support structure for locating the vibratory source in a particular orientation.

17. A sound transmission system comprising:
a pad having a plurality of speakers disposed therein; and
a sound system in communication with the speakers, the sound system having a plurality of input ports and an input selector switch.

18. The system of claim 17, and further comprising a sound intensity sensor in communication with the sound system.

19. The system of claim 18, wherein the sound system includes an automatic volume control in communication with the sound intensity sensor.

20. The system of claim 17, and further comprising a remote control in communication with the sound system.

21. The system of claim 21, and further comprising a heating element disposed within the pad.

22. A method of applying sound therapy at high volume levels comprising:
providing a sound transmission pad in communication with a sound source having a volume control;
setting a sound intensity level for ambient sound surrounding the pad;
monitoring the sound intensity level of the ambient sound; and
adjusting the volume control to maintain the ambient sound level within the set sound intensity level.
